(19) United States
(12) Patent Application Publication
(10) Pub. No.: US 2001/0032887 A1
(43) Pub. Date: Oct. 25, 2001

(54) Precision dispensing tip and method

(76) Inventor: Alan L. Everett, East Aurora, NY (US)

Correspondence Address: Martin G. Linihan, Hodgson, Russ, Andrews, Woods & Goodyear, LLP, Suite 2000, One M&T Plaza, Buffalo, NY, 14203-2391, US

(21) Appl. No.: 09/761,624

(22) Filed: Jan. 17, 2001

Related U.S. Application Data
(63) Continuation-in-part of application No. 09/253,147, filed on Feb. 19, 1999, now Pat. No. 6,257,444.

(51) Int. Cl. B05D 1/00; B05B 17/00

(52) U.S. Cl. 239/1; 239/589; 239/594

(57) ABSTRACT

A nozzle or tip for use in precision dispensing systems which provides a continuous, uninterrupted flow of fluid therethrough. The tip comprises a body having an inlet at one end adapted for connection to a dispensing head or pump and an outlet at the other end for positioning adjacent a location on the surface onto which the fluid is to be dispensed. A passage in the body of the tip connects the inlet to the outlet, and is shaped to conduct fluid from the inlet to the outlet in a continuous and uninterrupted manner. The passage has a converging portion extending from the inlet to an intermediate location in the body and a constant diameter portion joining the converging portion to the outlet. The body of the tip is of ceramic material, preferably injection molded ceramic material. The tip can be fitted in a metal housing which can be provided with a standoff pin for spacing the outlet end of the tip from the surface onto which fluid is to be dispensed.

### CROSS REFERENCE TO A RELATED APPLICATION

This application is a continuation-in-part of copending application Ser. No. 09/253,147 filed Feb. 19, 1999 and entitled “Precision Dispensing Apparatus And Method.”

### BACKGROUND OF THE INVENTION

This invention relates to the art of precision dispensing of small quantities of fluid, for example, viscous material such as adhesive on circuit boards and other surfaces, and more particularly to a new and improved precision dispensing apparatus and method for accomplishing the foregoing.

One area of use of the present invention is dispensing small quantities of viscous material, although the principles of the present invention can be variously applied to dispensing other types of fluids. Systems and methods for the deposition of drops of adhesive, conductive epoxy, soldering paste, and other viscous fluids at discrete locations on various surfaces are used extensively in modern manufacturing techniques. Such systems include a fluid dispenser and computer controlled apparatus for directing the fluid dispenser to precise locations on any surface. The former includes a dispensing head or pump and a nozzle or tip at the outlet of the head or pump. The latter can include a gantry arrangement for X-Y axis movement of the dispenser, a moving table for use with a stationary dispenser or split axis systems for moving the table in one axis and the dispenser in the other.

### SUMMARY OF THE INVENTION

In the precision dispensing of small amounts of viscous material it is important to provide consistent shapes of the material applied to a series of locations on a surface and to do so at a relatively fast rate of travel from location to location. The present invention provides a nozzle or tip for use in precision dispensing systems which provides a continuous, uninterrupted flow of fluid therethrough. The tip comprises a body having an inlet at one end adapted for connection to a dispensing head or pump and an outlet at the other end for positioning adjacent a location on the surface onto which the fluid is to be dispensed. A passage in the body of the tip connects the inlet to the outlet, and is shaped to conduct fluid from the inlet to the outlet in a continuous and uninterrupted manner. The passage has a converging portion extending from the inlet to an intermediate location in the body and a constant diameter portion joining the converging portion to the outlet. The body of the tip is of ceramic material, preferably injection molded ceramic material. The tip can be fitted in a metal housing which can be provided with a standoff pin for spacing the outlet end of the tip from the surface onto which fluid is to be dispensed.

The foregoing and additional advantages and characterizing features of the present invention will become clearly apparent upon a reading of the ensuing detailed description together with the included drawings wherein:

### BRIEF DESCRIPTION OF THE DRAWING FIGURES

FIG. 1 is a perspective view of the dispensing tip according to the present invention;

FIG. 2 is a side elevational view thereof;

FIG. 3 is an enlarged longitudinal sectional view thereof;

FIG. 4 is a diagrammatic view further illustrating the dispensing tip according to the present invention;

FIG. 5 is a perspective view of an assembly incorporating the dispensing tip of the present invention;

FIG. 6 is a side elevational view of the assembly of FIG. 5; and

FIG. 7 is a view similar to FIG. 6 rotated ninety degrees.

### DETAILED DESCRIPTION OF THE INVENTION

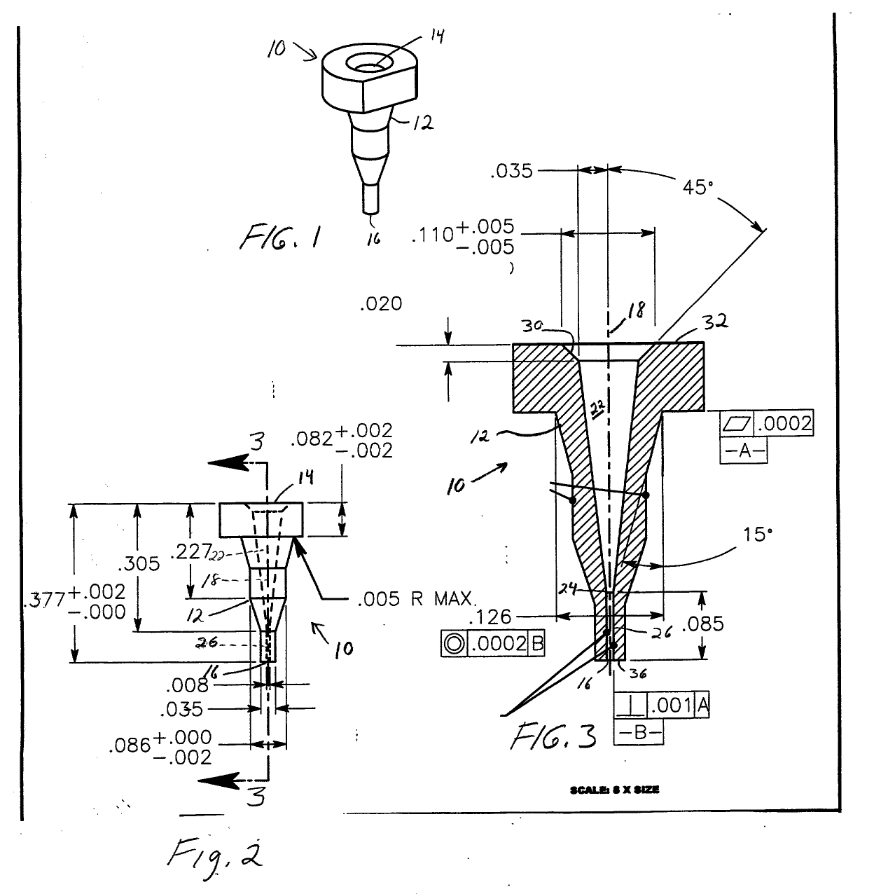

Referring to FIGS. 1-3, the dispensing tip or nozzle 10 according to the present invention is for use with precision dispensing apparatus such as a dispensing head or pump for delivering controlled amounts of fluid to a selected location. An example of one such precision dispensing pump is shown and described in pending U.S. patent application Ser. No. 09/253,147 filed Feb. 19, 1999 and entitled “Precision Dispensing Apparatus And Method”, the disclosure of which is hereby incorporated by reference. Dispensing tip 10 comprises a body 12 having an inlet 14 at one end and an outlet 16 at another end of the body. As shown in FIGS. 2 and 3, inlet 14 and outlet 16 are at opposite ends of the body 12 and are located on and are concentric with the longitudinal axis 18 of body 12.

Inlet 14 of dispensing tip 10 is adapted for connection in fluid communication with precision dispensing apparatus such as the pump described in the above-referenced application. Tip 10 can be connected to such apparatus in various ways and by various mechanisms. An illustrative arrangement for connecting a dispensing tip to such dispensing apparatus is shown and described in pending U.S. patent application Ser. No. 09/360,972 filed Jul. 27, 1999 and entitled “Quick Change, Micro Dispensing Tip With Disposable Liner”, the disclosure of which is hereby incorporated by reference.

Dispensing tip 10 further comprises a passage in body 12 which connects inlet 14 and outlet 16 so as to place them in fluid communication with each other. In accordance with the present invention the passage is shaped to conduct fluid from inlet 14 to outlet 16 in a continuous and uninterrupted manner so that there are no discontinuities in the fluid flow and no turbulence is introduced to the flow. In particular, the passage includes a first portion 22 which converges in a direction from inlet 14 to an intermediate location 24 in body 12 and a second portion 26 of constant diameter extending from the intermediate location 24 to outlet 16. Both portions 22 and 26 of the passage extend along and are concentric with the longitudinal axis 18 of body 12. Body 12 can be provided with a chamfered surface 30 between end face 32 and the beginning of passage portion 22 to accommodate connection to the outlet of the dispensing head or pump. The junction between passage portions 22 and 26 at intermediate location 24 should be as smooth and continuous as possible so as not to introduce any turbulence and/or discontinuities in the fluid flow. Also, as can be seen from FIG. 3, the transition between passage portions 22 and 24 is very gradual and not abrupt so that the flow from portion 22 into portion 26 is smooth, continuous and uninterrupted. In particular, the surface wall of passage 26 is substantially parallel to longitudinal axis 18 and the surface wall of passage 22 is disposed at a very small acute angle, typically less than 15°, with respect to longitudinal axis 18 so that a very gradual transition exists between the wall surfaces of the two passage portions. By way of further explanation, passage portion 22 is in the shape of a frustum of a right circular cone and passage portion 26 is cylindrical. Outlet 16 is circular in shape and is defined at the junction of the end of passage portion 26 and end face 36. End faces 32 and 36 are substantially parallel to each other and are disposed substantially at right angles to longitudinal axis 18.

Tip 10 is used in precision dispensing apparatus typically for deposition of drops of adhesive, conductive epoxy, soldering past and other viscous fluids at discrete locations on surfaces, such as circuit boards in precision electronic manufacturing operations. Alternatively, instead of depositing discrete drops at spaced locations, tip 10 can be used to deposit such material continuously along a linear or curvilinear path. For such applications, the diameter of outlet 16 typically is in a range of from about 0.003 inch to about 0.030 inch. A drop of material leaving outlet will have a diameter substantially equal to the diameter of outlet 16. When the material contacts the surface to which it is applied, such as a circuit board, there is bound to be some re-shaping and or spreading of the material so that the resulting dot on the surface typically will have a diameter slightly larger than the diameter of outlet 16. The same holds true for the case of continuous deposition previously mentioned, i.e. the width of the path of material deposited on the surface typically will be slightly greater than the diameter of outlet 16.

In the precision dispensing of small quantities of fluid, for example viscous materials such as adhesive on circuit boards, it is important to maintain consistency in the size and shape of the dots of material applied to the surface. Coupled with this requirement is the need to place the dots on the surface as quickly and accurately as possible. Any trailing of material from outlet 16 which could result in tear drop shaped dots needs to be avoided. All the foregoing requirements and objectives dictate a continuous, uninterrupted flow of material through tip 10. The material should flow through tip 10 in a manner avoiding introduction of turbulence to the fluid flow. This is accomplished by shaping the interior passage of tip 10 in accordance with the present invention. The material is funnelled smoothly and continuously along passage portion 22 and the uninterrupted nature of the flow is enhanced by the gradual convergence of passage portion. The smooth transition between portions 22 and 26 avoids introduction of turbulence and any other flow interruptions or irregularities. The cylindrical shape of passage portion 26 contributes to forming or shaping the ball of material leaving outlet 16 as well as to maintaining the consistency of the shape of the material as it is discharged.

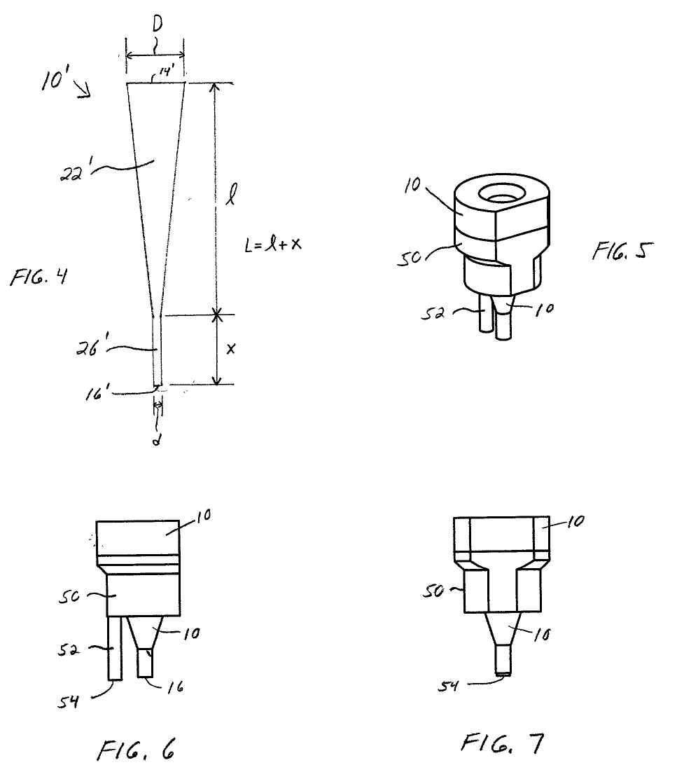

The operation of tip 10 of the present invention is illustrated further by the diagrammatic view of FIG. 4 which represents inlet 14′, outlet 16′ and passage portions 22′ and 26′ of tip 10′. D is the diameter of inlet 14′ which also is the inlet of passage portion 22′. The length of passage portion 22′ is l, and the length of passage portion 26′ is x. The overall length L=l+x can be viewed as the length of tip 10′. The diameter of outlet 16′ is d. If D, L, l and x are held constant, the exit dot size is directly proportional to d. The dot size is defined as the diameter of the hemispherically shaped dot of material exiting the outlet 16′. In addition, in the dispensing tip of the present invention, if D, L and d are held constant, the exit dot size is directly proportional to the ratio of x to l. Thus, in the dispensing tip 10 of the present invention, the size of the drop of material leaving the outlet 16 can be influenced by a change in the lengths of either or both the passage portions 22 and 26.

By way of further example, in an illustrative dispensing tip 10, the axial distance from end face 32 to intermediate location 24 is 0.292 inch, the axial length of the chamfered region is 0.020 inch, the axial length of passage portion 26 is 0.085 inch, the diameter of passage portion 26 and outlet 16 is 0.008 inch, the diameter of end face 36 is 0.035 inch, the diameter of passage portion 22 adjacent inlet 14 is 0.070 inch, the diameter of inlet 14 is 0.110 inch and the overall length of tip 10 between end faces 32 and 36 is 0.377 inch.

To facilitate manufacture of dispensing tip 10 in the dimensions illustrated herein, body 12 is of molded ceramic material, in particular injection molded zirconia ceramic material. In addition, the ceramic material, unlike plastic, is compatible with the materials typically dispensed by tip 10. To achieve the small dimensions, particularly that of outlet 16 as well as to have smooth transitions such as at intermediate location 24, it would be extremely difficult and costly to machine body 12 from metal.

Dispensing tip 10 can be incorporated in an assembly including a housing 50 shown in FIGS. 5-7 which is shaped to receive and hold tip 10 as shown. A pin 52 press fit at one end into a bore provided in housing 50 serves as a standoff. There is a slight spacing between the end 54 of pin 52 and outlet 16 so that when end 54 contacts a surface outlet 16 is spaced from the surface. Housing 50 and pin 52 are of metal, such as stainless steel, and serve to absorb the impact forces arising from contact with the surface thereby protecting ceramic tip 10 from such impact forces.

While an embodiment of the present invention has been described in detail, that is done for the purpose of illustration, not limitation.

1. A dispensing tip for use with precision dispensing apparatus for delivering controlled amounts of fluid to a selected location comprising:
a) a body having an inlet at one end adapted for connection in fluid communication with precision dispensing apparatus and having an outlet at another end of the body;
b) a fluid conducting passage in the body for connecting the inlet to the outlet, the passage having a first portion converging in a direction from the inlet to an intermediate location in the body and a second portion of constant diameter extending from the intermediate location to the outlet; and
c) so that the passage conducts fluid from the inlet to the outlet in a continuous and uninterrupted manner.

2. A dispensing tip according to claim 1, wherein the second portion of the passage has a diameter in a range from about 0.003 inch to about 0.030 inch.

3. A dispensing tip according to claim 1, wherein the body is of ceramic material.

4. A dispensing tip according to claim 1, wherein the body is of injection molded ceramic material.

5. A dispensing tip according to claim 1, wherein the body is of injection molded zirconia ceramic material.

6. A dispensing tip according to claim 1, in combination with a protective housing.

7. A dispensing tip according to claim 6, further including a standoff member extending from the housing for contacting a surface to which fluid is to be dispensed for spacing the outlet of the tip from the surface.

8. A dispensing tip according to claim 1, wherein the body has a longitudinal axis and the first and second passage portions extend along the axis and wherein the diameter of a drop of fluid leaving the outlet is directly proportional to the ratio of the axial length of the second passage portion to the axial length of the first passage portion.

9. A dispensing tip for use with the precision dispensing apparatus for delivering controlled amounts of fluid to a selected location comprising:
a) a body of ceramic material having an inlet at one end adapted for connection in fluid communication with precision dispensing apparatus and having an outlet at another end of the body; and
b) a fluid conducting passage in the body for connecting the inlet to the outlet, the passage being shaped to conduct fluid from the inlet to the outlet in a continuous and uninterrupted manner.

10. A dispensing tip according to claim 9, wherein the body is of injection molded ceramic material.

11. A dispensing tip according to claim 9, wherein the body is of injection molded zirconia ceramic material.

12. A dispensing tip according to claim 9, wherein the outlet has a diameter in the range from about 0.003 inch to about 0.030 inch.

13. A method of precision dispensing controlled amounts of fluid to a selected location comprising:
a) providing a dispensing tip having an inlet for receiving fluid from precision dispensing apparatus, an outlet for discharging fluid to the location and a passage between the inlet and outlet shaped to define a continuous and uninterrupted fluid flow from the inlet to the outlet;
b) introducing fluid to the inlet of the dispensing tip;
c) funnelling the flow of fluid from the inlet toward the output;
d) transitioning the flow to a constant cross-section flow into the outlet; and
e) discharging the fluid from the outlet to the location in a body of fluid having a dimension in the range from about 0.003 inch to about 0.030 inch.
